(19) United States
(12) Patent Application Publication
(10) Pub. No.: US 2023/0056793 A1
(43) Pub. Date: Feb. 23, 2023

(54) AI-BASED SEAMLESS POSITIONING CALCULATION DEVICE AND METHOD

(71) Applicant: JastecM CO., LTD., Gyeonggi-do (KR)

(72) Inventor: Yongbeom BAEK, Gyeonggi-do (KR)

(21) Appl. No.: 17/412,364

(22) Filed: Aug. 26, 2021

(30) Foreign Application Priority Data
Aug. 19, 2021 (KR) 10-2021-0109717

(51) Int. Cl. G06F 16/215; G06F 16/22; G06K 9/62; G06F 16/2458; G06N 20/00

(52) U.S. Cl. CPC G06F 16/215; G06F 16/2246; G06K 9/6288; G06F 16/2477; G06N 20/00

(57) ABSTRACT

An AI-based seamless positioning calculation device according to an embodiment of the present invention includes a domain provided with a sensor detecting a subject; a positioning calculation unit receiving sensing data generated by the sensor and performing positioning calculation; and a database storing the sensing data and data generated in the positioning calculation. The positioning calculation unit calculates the positioning and performs data fusion and artificial intelligence (AI) learning for the sensing data. An AI-based seamless positioning method according to the present invention includes inputting source data required for positioning calculation of a subject, which is selected from a database storing sensing data generated by a sensor detecting the subject; performing AI learning for the positioning calculation; and displaying a result to visually display the positioning.

### CROSS REFERENCE TO RELATED APPLICATION

The present application claims priority to Korean Patent Application No. 10-2021-0109717, filed Aug. 19, 2021, the entire contents of which is incorporated herein for all purposes by this reference.

### BACKGROUND

### 1. Field of the Invention

The present invention relates to an AI-based seamless positioning calculation device and method for data precision.

### 2. Description of the Related Art

Positioning calculations may be followed by large-scale operations on big data. Herein, when fusing or calculating sensing data obtained by the sensor, the time required for fusion or calculation may gradually accumulate, resulting in time delay. Accordingly, transmission efficiency to the central processing unit may decrease, and processing efficiency of the processor may also decrease.

### SUMMARY

An objective of the present invention is to provide AI-based positioning calculation device and method used for AI learning in order to increase data precision and reliability when performing large-scale data calculation processing including data fusion or sensor fusion in positioning calculation.

An AI-based seamless positioning calculation device according to the present invention may include a domain provided with a sensor detecting a subject; a positioning calculation unit receiving sensing data generated by the sensor and performing positioning calculation; and a database storing the sensing data and data generated in the positioning calculation. The positioning calculation unit may calculate the positioning and perform data fusion and artificial intelligence (AI) learning for the sensing data.

An AI-based seamless positioning calculation method according to the present invention may include inputting source data required for positioning calculation of a subject, which is selected from a database storing sensing data generated by a sensor detecting the subject; performing AI learning for the positioning calculation; and displaying a result to visually display the positioning.

According to the present invention, in order to perform accurate and reliable positioning calculation, the three-dimensional spatio-temporal data stored in a database can be optimized and stored through the data indexing unit.

According to the present invention, it is possible to perform AI learning using sensing data generated from a single sensor or two or more sensors. In addition, the present invention has an advantage of increasing the accuracy and reliability of positioning calculation of a subject, by data fusion or sensor fusion of different sensing data, common data format, and AI learning.

According to the present invention, the positioning calculation unit can perform data fusion or sensor fusion and perform AI learning by the AI learning unit, even in the case of data generated by a single sensor.

According to the present invention, data fusion by a single sensor can be performed between data sets with a time difference, and AI learning by a single sensor can be performed between input data in a time series.

In the case of a single sensor, it is possible to perform AI learning or positioning calculation without a need to convert data to have a common data format between different sensing data.

The conversion step may be to convert the sensing data selected in the input step to have a set common data format when the sensing data have different data formats from each other. The positioning calculation unit PTD can allow for converting different data formats into the common data format to reduce the complexity of information calculation including positioning, reducing the time required for calculation, and reducing the burden of calculation processing.

The fusion step can allow for fusing the sensing data which is converted to have the common data format in the conversion step. In addition, the fusion step may be to arrange, in a time series, the sensing data converted in the conversion step. Herein, the fusion step and the conversion step may be performed simultaneously.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is an explanatory diagram showing a positioning calculation step according to an embodiment of the present invention;

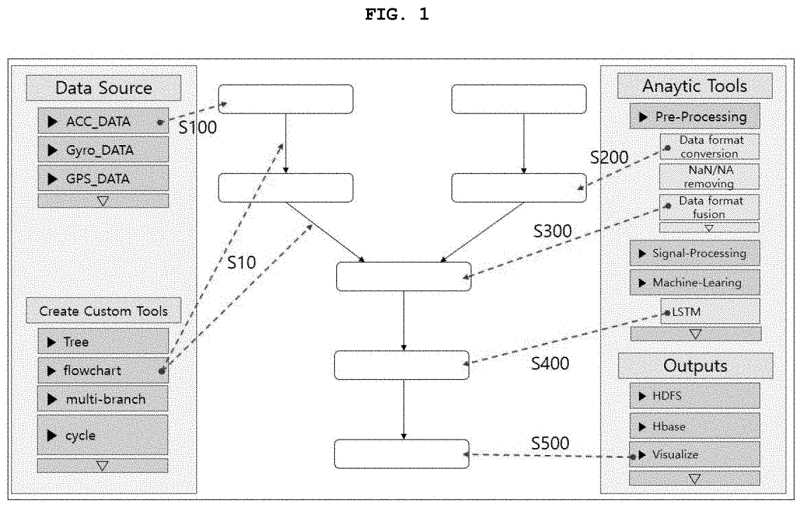

FIG. 2 is an explanatory diagram showing a positioning calculation step according to another embodiment of the present invention;

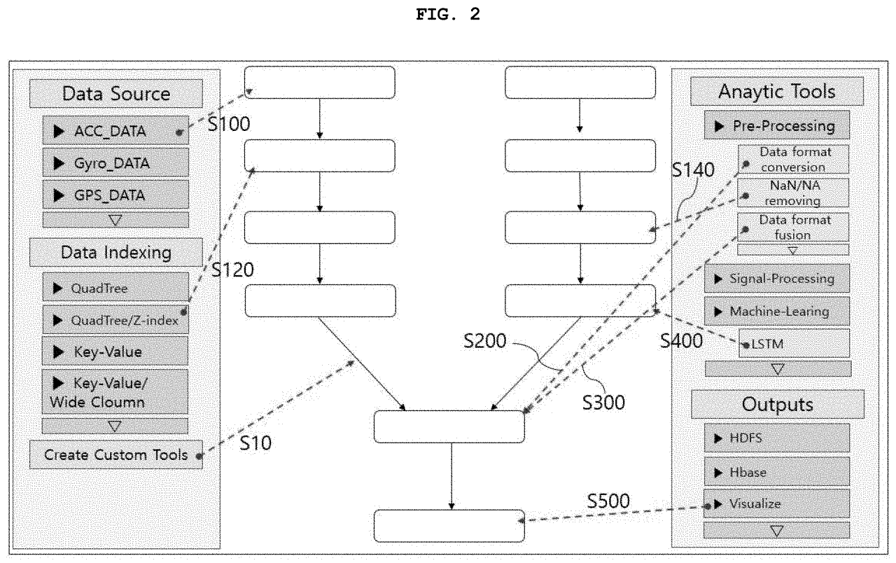

FIG. 3 is a schematic configuration diagram showing a device according to the present invention;

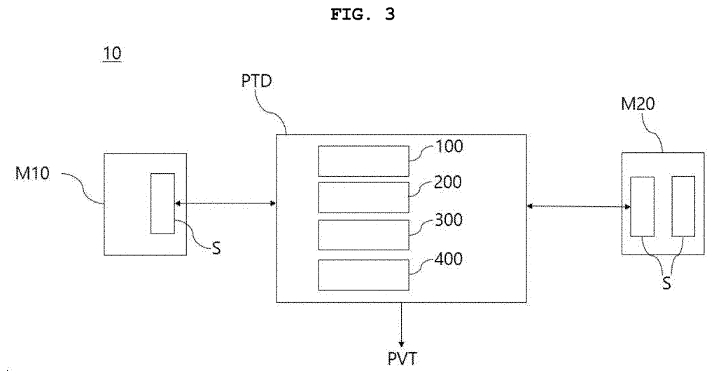

FIG. 4 is an explanatory diagram showing the data indexing unit according to the present invention;

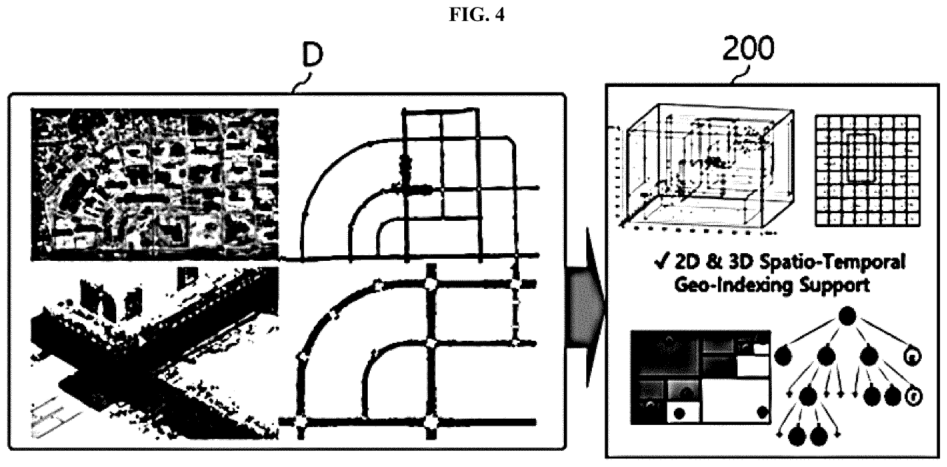

FIG. 5 shows a data indexing unit according to the present invention;

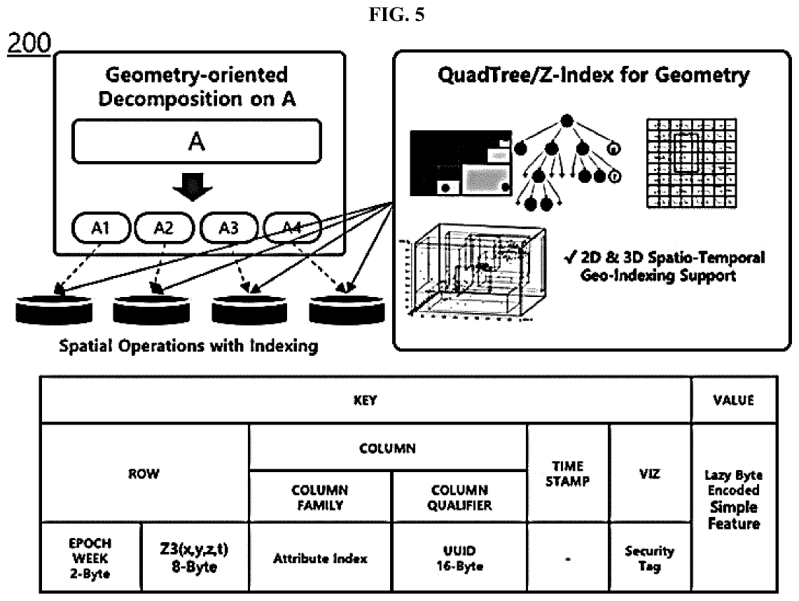

FIG. 6 shows an AI learning unit according to the present invention; and

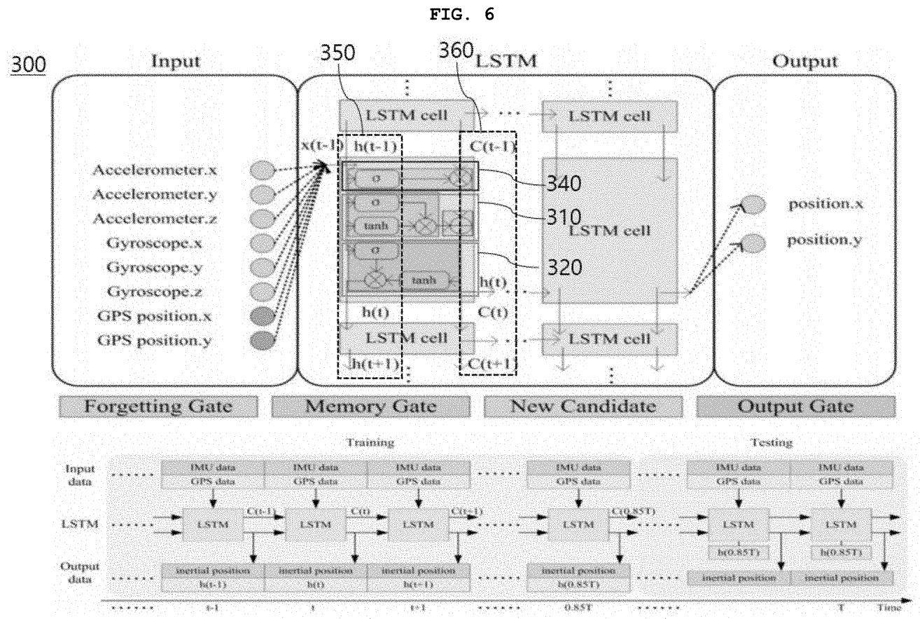

FIG. 7 is a block diagram showing an overall flow according to the present invention.

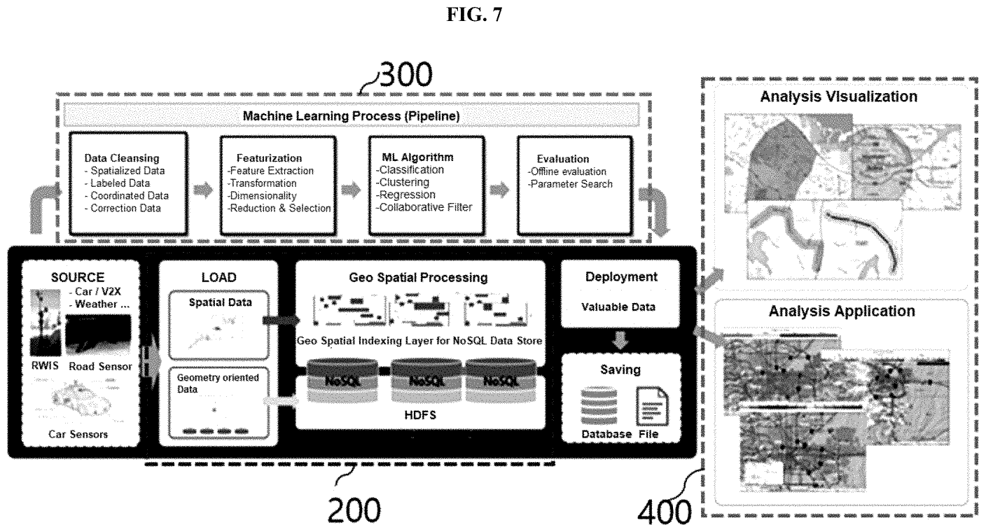

### DETAILED DESCRIPTION

A precise and reliable positioning calculation process according to the present invention may include at least one of data indexing, data storage, sensor fusion or data fusion, AI learning, and location calculation.

A data indexing unit 200 that is capable of classifying sensing data D and a database 100 that is capable of storing the classified data may be provided in order to use data fusion or AI learning in an optimized state.

The database 100 may be involved in storing intermediate products in the process of data fusion or AI learning for the final positioning calculation, as well as first inputting the sensing data D with the sensor and then storing the same in an index manner. The positioning calculation may be performed via data fusion or AI learning using a terminal. A user or an administrator may make the positioning calculation structure model using a drag-and-drop method in a user interface (UI) of the terminal.

The AI-based positioning calculation method for data precision according to the present invention may include at least one of a structure step S10, an input step S100, an indexing step S120, a data cleaning step S140, a conversion step S200, a fusion step S300, a learning step S400, and a result display step S500.

In each step of the present invention, the user or administrator may make the calculation structure model in various ways, using, for example, a drag-and-drop method via clicking the table of contents of each corresponding step.

In the input step S100, it is possible to select the sensing data D for data fusion or AI learning. The sensing data D may be generated by a single sensor or may be generated by two or more sensors.

A positioning calculation unit PTD may perform data fusion or sensor fusion even in the case of sensing data D generated by a single sensor, and may perform AI learning using an AI learning unit 300. The data fusion by the single sensor may be performed between data sets with a time difference, and the AI learning by the single sensor may be performed between input data in a time series. In the case of the single sensor, it is possible to perform AI learning or positioning calculation without a need to convert data to have a common data format between different sensing data D.

According to an embodiment, GPS and IMU will be described with respect to data fusion between two or more sensors, or AI learning.

The data selected in the input step S100 may be referred to source data. The source data may include, for example, acceleration data, angular velocity data, and GPS data of a subject. The acceleration data and the angular velocity data may be sensing data D detected from the IMU, and the GPS data may be sensing data D detected from the GPS sensor.

The structure step S10 may be a step of determining a structure for the entire positioning calculation or between each step of the positioning calculation method. For example, the structure step S10 may include a tree structure, a flowchart, a multi-branch, and a cycle structure. In the structure step S10, the data corresponding to each of other steps may be input and processed and then changed, and the entire structure may be selected before the input step S100. Therefore, the structure step (S10) may be performed at any time before displaying a finally calculated positioning result in the result display step (S500)

The conversion step S200 may be to convert the sensing data selected in the input step S100 to have a set common data format when the sensing data have different data formats from each other. The positioning calculation unit PTD allows for converting different data formats into the common data format to reduce the complexity of information calculation including positioning, reducing the time required for calculation, and reducing the burden of calculation processing.

The fusion step S300 may allow for fusing the sensing data which is converted to have the common data format in the conversion step S200. In addition, the fusion step S300 may be to arrange, in a time series, the sensing data converted in the conversion step S200. Herein, the fusion step S300 and the conversion step S200 may be performed simultaneously.

The learning step S400 may be to perform AI learning before the AI learning unit 300 calculates output data corresponding to the input data. The learning step S400 may be performed after the conversion step S200 and the fusion step S300, or may be performed before the conversion step S200 and the fusion step S300.

In a case that the learning step S400 is performed before the conversion step S200 and the fusion step S300 and in a case that the learning step S400 is performed after the conversion step S200 and the fusion step S300, the input data set used for AI learning may be different from each other, and the positioning calculation result may be different from each other. The determination of which of the two cases proceeds may be performed according to machine learning (ML) used by the AI learning unit 300, a data format of the sensing data, a time required for learning, or a total of positioning calculation time.

The result display step (S500) may be to provide the calculated positioning. For example, the result display step S500 may include a visualization step in which the subject's positioning movement is displayed on a map. The result display step S500 may be performed by a result display unit 400.

After the input step S100, an indexing step S120 may be provided. The indexing step S120 may be to structure the sensing data used for data fusion or AI learning to be stored in the database 100. The indexing step S120 may use, for example, a technique such as a quadtree, z-index, key-value, and wide-column store and, in particular select a technique that is suitable for restructuring or optimizing four-dimensional spatio-temporal data in the positioning calculation.

When selecting the source data in the input step S100, the source data may be have already stored in the database 100. The source data may be in a structured state by the data indexing unit 200 before being stored in the database 100.

Although the indexing step S120 may not be used when the user or administrator maintains the data storage method specified in advance, the storage structure of each sensing data may be selected again in the indexing step S120 after selecting the source data in the input step S100.

The data cleaning step S140 may be to confirm whether data used for learning has no missing values (NaN) or outliers. The missing values may be wrong values or indeterminate values. That is, the data cleaning step S140 may be performed before the learning step S400.

When a moving subject moves, the moving subject may be detected by sensors provided in the domain, and the sensors may generate sensing data. The sensing data may be transmitted to the positioning calculation unit PTD that performs sensor fusion or data fusion.

Accurate positioning calculation of the moving subject can be performed by various sensors. Accurate positioning calculation of the moving subject may be performed by sensor fusion of a plurality of sensors included in a domain. Positioning P, velocity V, and timing T may be calculated in the positioning calculation. Therefore, the positioning calculation unit PTD may perform precise and reliable positioning calculation using data fusion and AI learning.

The domain may include, for example, a first domain M10 and a second domain M20, and a sensor may be provided in each domain. When the positioning changes as the moving subject moves, the moving subject may continuously stay in the same domain or move to another domain over time. Different sensors may belong to the same domain or may belong to different domains.

The sensors include Wi-Fi (WLAN), ultra-wide band (UWB)), global navigation satellite system (GNSS), global positioning system (GPS), Lidar, camera, radar, inertial measurement unit (IMU), magnetometer, telecom received signal strength indication (Recv), or Odometer.

The different sensing data may be generated by a single sensor or may be generated by different sensors. For example, the different sensing data generated by the single sensor may mean a data set with a time difference.

A database 100 for storing the sensing data may be provided. When the sensing data is stored, the sensing data may be stored in an optimized state by the data indexing unit 200.

The optimized state of the sensing data may mean that the sensing data is easily identified between data, the sensing data is suitable for a common data format for data fusion or sensor fusion, and the sensing data has a data format suitable for AI learning performed by the AI learning unit 300.

The positioning calculation may include calculation of positioning P, velocity V, and timing T. Accordingly, spatio-temporal data may be used for the positioning calculation, and may include three-dimensional coordinates and time. For example, geometry-oriented sensing data may be optimally structured by quadtree/z-index.

The quadtree may be a tree with four child nodes, and may be one of techniques for compressively storing a large amount of coordinate data in memory. The quadtree may be suitable for restructuring a two-dimensional plane. When it is necessary to structure a three-dimensional space, the z-index may be used together with the quadtree. The z-index may specify the arrangement order of data and allow for determining an order of overlapping two-dimensional planes so that the three-dimensional space may be structured or indexed.

The data indexing unit 200 may use a key-value type or a wide column store type as a data classifying method. These methods may be to structure data in a not only structured query language (NoSQL) method.

The key-value type and the wide column store type may be used together. For example, a table may include a row and a column, and a name and format of the column may be different for each row. In this case, the wide column store type may be interpreted as a two-dimensional key-value.

A column may include a name, a value, a column family, a column qualifier, or a timestamp. The timestamp may mean a date and time at which data is saved and may be used when classifying versions of data.

Each row can have its own column family set. Each row can have columns with different numbers, names, and data types from other rows. The wide column store type enables massive scalability, and thus is effective for processing data across clusters of large systems and provides fast data loading and query.

The AI learning unit 300 generally calculates output data after going through a series of learning processes when input data is entered.

For example, the AI learning unit 300 may have a neural network structure for learning and prediction. The neural network may include an artificial neural network (ANN), a deep neural network (DNN), a convolutional neural network (CNN), and a recurrent neural network (RNN). Therefore, the AI learning unit 300 may be, for example, a long short-term memory (LSTM). Herein, the LSTM may be obtained by extending short-term memory storage to enable long-term memory storage with respect to the RNN.

Data input to the LSTM may be encoded in a manner as to be easily processed by the LSTM, or may have a data format that is suitable for processing. For example, the input data learned by the AI learning unit 300 may be coming from a single sensor or from two or more sensors.

When the sensing data is input from two or more sensors, each sensor may have a different data format from each other. When the AI learning unit 300 is provided for each sensor, the learning may be performed separately for the data format of each sensor, and may be performed together for multiple sensing data after formats of the multiple sensing data are converted into a common data format.

When the AI learning unit 300 inputs a series of data to a neural network, the neural network may calculate an output value according to a neural circuit. When an error is obtained by comparing the output value with a value of the actual data, and this error is input in reverse, the AI learning unit 300 may change parameters or weights in order to make corrections for lowering the error. Such series of processes may be referred to as learning. When target input data is input by repeatedly performing learning, the AI learning unit 300 may output the output value based on the learning so far, and herein the output value may become a positioning prediction value.

The LSTM may be a model that learns what information to input, output, and store in a manner that is similar to human information processing.

The AI learning unit 300 may include an input unit 310 that receives the input data, and an output unit 320 that calculates the output data predicted through operation based on the input data.

The input data may be restructured so that the input unit 310 of the AI learning unit 300 receives the input data through the data index unit 200 to perform an operation.

When the error occurs as a result of comparing the output data with the target data, an error comparator 330 may correct weights or parameters in the AI learning unit 300 to output a value similar to the target data. A weighting unit 370 for updating weights of each component in the AI learning unit 300 may be provided in order to minimize the error from the error comparator 330.

The AI learning unit 300 may be provided with a forgetting unit 340 that is capable of forgetting unnecessary information, and a long-term storage unit 360 that is used for long-term memory.

What is claimed is:

1. An artificial intelligence (AI)-based seamless positioning calculation device, comprising:
a domain provided with a sensor detecting a subject;
a positioning calculation unit receiving sensing data generated by the sensor and performing positioning calculation; and
a database storing the sensing data and data generated in the positioning calculation,
wherein the positioning calculation unit calculates the positioning and performs data fusion and artificial intelligence (AI) learning for the sensing data.

2. The device of claim 1, further comprising:
a data indexing unit,
wherein the data indexing unit stores the sensing data in the database and restructures the sensing data in a structure suitable for the data fusion or the AI learning, and the sensing data and the positioning are four-dimensional spatio-temporal data combined with three-dimensional spatio-temporal data.

3. The device of claim 1, further comprising:
an AI learning unit performing the AI learning,
wherein input data input for the AI learning is sensing data;
when the sensing data is transmitted from a single sensor, the data fusion or the AI learning is sensing data with a time difference by the single sensor; and
when the sensing data is transmitted from two or more sensors, the positioning calculation unit converts different data formats of different sensors into a common data format, and the data fusion or the AI learning uses sensing data of the common data format.

4. The device of claim 1, further comprising:
a data indexing unit restructuring the sensing data,
wherein the data indexing unit includes quadtree, z-index, key-value, and wide column store as a method of restructuring the sensing data;
the quadtree is a tree with four child nodes, and is one of techniques for compressively storing a large amount of coordinate data in memory;
the z-index specifies an arrangement order of the data;
the key-value and the wide column store is one of non-relational techniques of storing data;
the quad tree structures plane coordinates in a three-dimensional space; and
the z-index structures z-axis coordinates in the three-dimensional space.

5. The device of claim 1, further comprising:
an AI learning unit performing the AI learning,
wherein input data input for the AI learning is the sensing data;
a long short-term memory (LSTM) is included in a neural network structure in which the AI learning unit performs the AI learning; and
the AI learning unit includes:
an input unit receiving the input data,
an output unit calculating the output data predicted through operations of the input data,
an error comparator correcting, when an error occurs as a result of comparing the output data with a target data, weights or parameters in the AI learning unit to output a value similar to the target data,
a weighting unit updating the weights in the AI learning unit provided to minimize the error of the error comparator,
a forgetting unit enabling forgetting unnecessary information in the AI learning unit,
a short-term memory unit provided for short-term memory of the AI learning unit, and
a long-term memory unit provided for long-term memory of the AI learning unit.

6. An AI-based seamless positioning calculation method, comprising:
inputting source data required for positioning calculation of a subject, which is selected from a database storing sensing data generated by a sensor detecting the subject;
performing AI learning for the positioning calculation; and
displaying a result to visually display the positioning.

7. The method of claim 6, further comprising:
converting the sensing data to have a common data format, when the sensing data input in the inputting of the source data has different data formats from each other; and
performing fusing for the sensing data converted to have the common data format in the converting of the sensing data,
wherein whether the converting of the sensing data and the performing of the fusing are performed before or after the performing of the AI learning is determined by at least one of machine learning ML used by the AI learning unit, the data format of the sensing data, the time required for the AI learning, and a total of positioning calculation time.

8. The method of claim 6, further comprising:
determining a structure between each step or an overall calculation structure for the positioning calculation,
wherein a tree structure, a flowchart, a multi-branch, and a cycle structure are included in the determining; and
the determining is performed before the displaying of the result.

9. The method of claim 6, further comprising:
performing indexing to structure the sensing data used for the data fusion or the AI learning to be stored in the database,
wherein the performing of the indexing is omitted when a predetermined data storage manner in the database is maintained in the positioning calculation; and
the performing of the indexing is proceeded after the inputting of the source data when changing the predetermined data storage manner in the database is changed in the positioning calculation.

10. The method of claim 6, further comprising:
performing data cleaning by checking whether there are no missing values (NaN) or outliers in the data used for the AI learning,
wherein the missing value is a wrong value or an indeterminate value; and
the performing of the data cleaning is proceeded before the performing of the AI learning.
